(19) United States
(12) Patent Application Publication
(10) Pub. No.: US 2026/0116572 A1
(43) Pub. Date: Apr. 30, 2026

(54) DEVICE FOR DETECTING THE POSITION OF A MOBILE PART, AND ASSOCIATED METHOD AND AIRCRAFT

(71) Applicant: SAFRAN NACELLES, Gonfreville-L'Orcher (FR)

(72) Inventor: Olivier Meriel, Moissy-Cramayel (FR)

(73) Assignee: SAFRAN NACELLES, Gonfreville-L'Orcher (FR)

(21) Appl. No.: 19/150,795

(22) PCT Filed: Jan. 25, 2024
(86) PCT No.: PCT/FR2024/050104

§ 371 Date: Jul. 24, 2025

(30) Foreign Application Priority Data
Jan. 31, 2023 (FR) 2300869

(51) Int. Cl. B64D 45/00

(52) U.S. Cl. CPC B64D 45/0005

(57) ABSTRACT

This device for detecting the position of a movable piece able to move between a first extreme position, a second extreme position and at least one intermediate position, comprises a fixed antenna and a plurality of radio-frequency identification tags arranged along the path of the movable piece between said extreme and intermediate positions, the device further comprising a mechanical contactor configured to establish an electrical connection between the antenna and a unique combination of at least one radio-frequency identification tag for each position of the movable piece.

### TECHNICAL FIELD

The invention generally relates to data acquisition systems in the aeronautical field, and more particularly relates to a device for detecting a mechanical position of a movable piece in an aircraft engine.

The invention especially relates to a device for detecting the position of a movable piece requiring neither a wired connection nor an onboard battery.

### PRIOR ART

The environment of an aircraft engine is very crowded and includes a lot of pieces of equipment to be monitored, whether to maintain the aircraft, to assist control or to help diagnose a possible technical problem.

In particular, it may be necessary to know the position of elements such as a thrust reverser door in order to ensure the aerodynamic performance linked to the engine performance of the aircraft.

In order to monitor these pieces of equipment, sensors are installed in the engine environment in order to detect and retrieve data relating to the observed equipment. These sensors have to meet several restrictions, including overall space restrictions so that they can be integrated into the engine environment, and position restrictions which require the sensors to be positioned in proximity to the equipment so that they are able to sense said data.

Thus, so-called “passive” sensors requiring neither an onboard battery nor a wired connection have been developed to meet these restrictions.

These sensors rely mainly on two technologies.

The first technology is piezoelectric technology. The piezoelectric sensors comprise a piezoelectric generator capable of converting a mechanical force undergone to an electric current. Nevertheless, these sensors have the drawback of only operating when the state of the movable piece changes, and therefore do not allow a subsequent verification or a request tending to obtain the position occupied by this movable piece.

The second technology is radio-frequency identification, commonly referred to as RFID. This technology operates using an RFID tag and an RFID reader that emits electromagnetic waves such as requests to query intended for the RFID tag.

So-called “passive” RFID tags operate without an onboard battery and without a wired connection, and draw their energy from the electromagnetic wave emitted by the RFID reader. RFID technology allows a certain variety of data such as temperature, voltage, humidity or pressure to be measured.

However, the very nature of a passive RFID tag implies that it is only capable of operating, that is detecting and retrieving data, when the RFID reader emits electromagnetic waves. Indeed, if an event to be monitored by the sensor occurs when the tag is not queried by the RFID reader, this event cannot be detected by the tag.

There is therefore no solution to have a mechanical position sensor of a movable piece that does not require neither an onboard battery nor a wired connection.

The present invention therefore aims to overcome the aforementioned drawbacks and to provide a device for detecting the mechanical position occupied by a movable piece requiring neither a wired connection nor an onboard battery.

One object of the present invention is therefore a device for detecting the position of a movable piece between a first extreme position, a second extreme position and at least one intermediate position, the detection device comprising a fixed antenna and a plurality of radio-frequency identification tags disposed along the path of the movable piece between said extreme and intermediate positions.

The device comprises a mechanical contact switch configured to establish an electrical connection between the antenna and a single combination of at least one radio-frequency identification tag for each position of the movable piece.

Advantageously, the mechanical contact switch is disposed around the movable piece and comprises a fixed armature and a movable portion secured to the movable piece.

Preferably, the fixed armature comprises a plurality of pairs of connection pins, each radio-frequency identification tag being associated with a single pair of pins comprising a first pin in contact with the radio-frequency identification tag to which said pair of pins is associated and a second pin in contact with the antenna.

Advantageously, the movable portion is secured to the movable piece, and comprises a plurality of gateways capable of conducting current between the two pins of a pair of connection pins.

Advantageously, the plurality of gateways are positioned on the movable piece so that, for each position occupied by the movable piece, current is transmitted only between the pins of the pairs associated with the radio-frequency identification tags forming the single combination of radio-frequency identification tag for said position occupied by the movable piece.

Another object of the invention is a method for detecting the position of a movable piece between a first extreme position, a second extreme position and at least one intermediate position, for implementing a detection device such as previously defined.

The method comprises the following steps of;
Emitting, by a remote radio-frequency identification reader, a request to query the position occupied by the movable piece intended for one of the tags of the plurality of tags,
Receiving, by the antenna, the request to query emitted by the radio-frequency identification reader,
Activating the radio-frequency identification tags of the single combination of radio-frequency identification tags for said position occupied by the movable piece,
Individually processing, by each radio-frequency identification tag activated, the request to query
Depending on the result of the processing, formulating, by the radio-frequency identification tag for which the request to query is intended, an individual response to the request to query, if this tag is activated,
Emitting, by the antenna, the individual response of the tag formulated to the radio-frequency identification reader.
Repeating the previous steps for each of the other tags of the plurality of tags, so that a request to query is emitted by the radio-frequency identification reader for each of the tags of the plurality of tags.
Determining the position occupied by the movable piece.

Advantageously, the radio-frequency identification tags of the plurality of tags each comprise a calculator, the step of individually processing, by each tag activated, the request to query comprising the following steps of, for each tag activated:
Demodulating the request to query,
Transmitting the demodulated request to the calculator, and
Verifying the validity of the request to query.

Advantageously, repeating the emitting step is performed after receiving a response to the previous request to query by the remote radio-frequency identification reader, or after a predetermined time during which no response has been received by the remote radio-frequency identification reader following the emission.

Another object of the invention is an aircraft comprising a detection device such as previously defined.

Advantageously, the device is capable of implementing a method such as previously defined.

### BRIEF DESCRIPTION OF THE DRAWINGS

Further purposes, characteristics and advantages of the invention will become apparent upon reading the following description, given merely as a non-limiting example, and made with reference to the appended drawings, in which:

FIG. 1 illustrates a device for detecting a mechanical position of a movable piece according to the invention;

FIG. 2 schematically illustrates an RFID tag of the device of FIG. 1;

FIG. 3 illustrates the device of FIG. 1 when the movable piece is in a first extreme position;

FIG. 4 illustrates the device of FIG. 1 when the movable piece is in an intermediate position;

FIG. 5 illustrates the device of FIG. 1 when the movable piece is in a second extreme position; and

FIG. 6 illustrates the steps of a method for detecting the movable piece according to the invention.

### DETAILED DISCLOSURE OF AT LEAST ONE EMBODIMENT

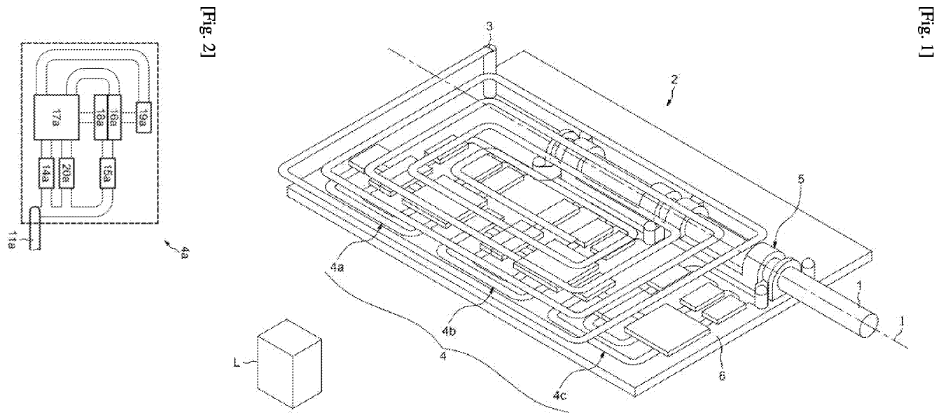

FIG. 1 schematically represents a device 2 for detecting a position occupied by a movable piece 1.

The movable piece 1 is for example a mechanical element, being herein tubular, of an aeronautical component on board an aircraft, the position of which is desired to be known. The movable piece 1 may also be prismatic or cylindrical, and may also simply be in fixed, pivot or ball connection with such an onboard aeronautical component.

The piece 1 is movable, for example during operation of the aeronautical component of the aircraft, and is thus capable of adopting a plurality of positions comprising and extending between a first extreme position, a second extreme position and at least one intermediate position between the first and second extreme positions.

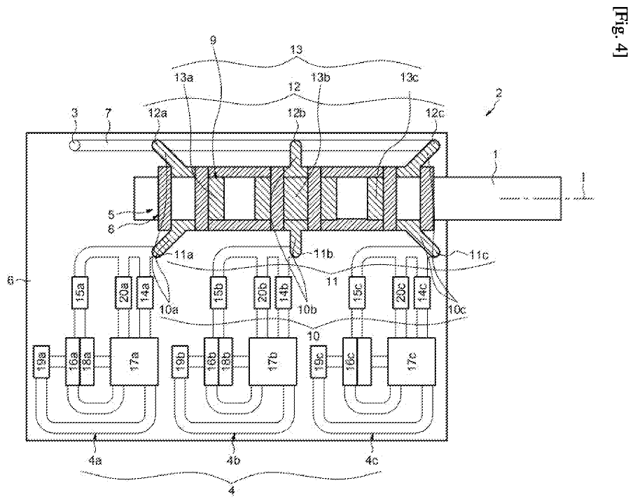

In the example illustrated in the figures, the movable piece 1 moves on an axis I especially visible in FIGS. 1, 3, 4 and 5. FIGS. 3, 4 and 5 each illustrating a top view of a possible position of the movable piece 1 as well as a state of the corresponding detection device 2.

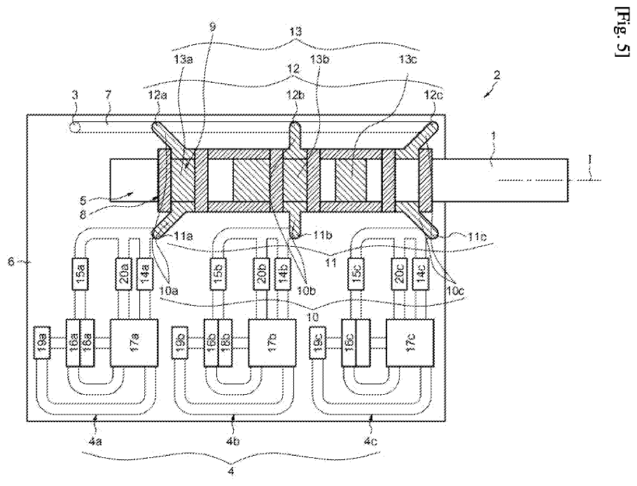

FIG. 3 therefore represents the detection device 2 according to the invention when the movable piece 1 occupies the first extreme position, FIG. 4 represents the detection device 2 when the movable piece 1 is in an intermediate position between the first extreme position and the second extreme position, and FIG. 5 represents the detection device 2 when the movable piece 1 is in the second extreme position.

The device 2 comprises a fixed antenna 3, a plurality of radio-frequency identification tags 4 called RFID tags and a mechanical contact switch 5. The assembly is mounted to a printed circuit board or circuit 6 on which at least one electrical connection track 7 is plotted (FIG. 3).

In the illustrated example, the device 2 thus comprises three RFID tags 4a, 4b and 4c.

The antenna 3 is illustrated in FIG. 1 and has not been included in the other figures for the sake of clarity.

The antenna 3 is an antenna conventionally used in the field of radio-frequency identification. It is to receive an electromagnetic wave sent by an RFID reader L, and to transform the electromagnetic wave received into an electrical signal.

The antenna 3 is connected to the electrical connection track 7 so that the antenna 3 transmits the electrical signal resulting from the electromagnetic wave through the track 7.

The mechanical contact switch 5 comprises a fixed armature 8 mounted to the board 6 and a movable portion 9 secured to the movable piece 1 or, in an embodiment, forming part of the movable piece 1. The fixed armature 8 comprises an axial passage oriented along the path of axis I of the movable piece 1, in which the movable piece 1 moves.

The RFID tags 4 are disposed on the board 6 in the vicinity and along the movement path of the movable piece 1 on the board 6. Thus, in the illustrated example, the RFID tags 4 are disposed in parallel to the axis I.

The mechanical contact switch 5 is connected on the one hand to the track 7 so as to be electrically connected to the antenna 3 and on the other hand to each of the RFID tags 4a, 4b, 4c of the plurality 4 of RFID tags. Thus, an electrical connection can be established between the antenna 3 and each of the RFID tags 4.

To this end, the fixed armature 8 of the mechanical contact switch 5 comprises a plurality of connection pins arranged in pairs 10.

More particularly, the fixed armature 8 comprises a pair of pins 10 for each RFID tag, so that each tag 4 is associated with a single pair of pins 10. Thus, in the example illustrated in the figures, the armature 8 comprises three pairs of pins 10a, 10b and 10c.

Thus, the RFID tag 4a is exclusively associated with the first pair of pins 10a, the RFID tag 4b is exclusively associated with the second pair of pins 10b, and the RFID tag 4c is exclusively associated with the third pair of pins 10c.

Each pair of pins 10 thus includes a first connection pin 11 connected to an RFID tag and a second connection pin 12 in contact with the track 7 connected to the antenna 3.

Thus, in the illustrated example, the pairs of pins 10a, 10b and 10c comprise respective first pins 11a, 11b and 11c connected each to an RFID tag 4a, 4b or 4c, and second pins 12a, 12b and 12c each connected to the antenna 3 through the track 7.

The two pins 11 and 12 of each pair of pins 10 are substantially radially aligned in a direction perpendicular to the movement path.

During its movement, the movable piece 1 moves in the contact switch 5 between the corresponding pins 11 and 12 of the fixed armature 8 and contacts the two pins 11 and 12 of the same pair 10 simultaneously.

The movable portion 9 comprises a plurality of electrically conductive gateways 13 capable of connecting the two pins 11 and 12 of a same pair of pins 10.

More specifically, the gateways 13 are conductive annular or prismatic elements enclosing part of the portion of the movable piece 1 inserted into the fixed armature 8. The gateways 13 are secured to the movable piece 1 for the movement of the movable piece 1 along the movement path. Alternatively, the movable portion 9 is machined directly on the movable piece 1 and is an element of this movable piece 1. The plurality of electrically conductive gateways 13 and the movable piece 1 can therefore form a single piece.

The gateways 13 have an axial dimension at least equal to the width of the ends of the pins 11 and 12 to be in contact with the gateways 13 in order to establish sufficient contact with the pins 11 and 12 of a same pair of pins 10.

In addition, each of the gateways 13 radially extends enough to contact the two pins 11 and 12 of a same pair of pins 10 when the movable piece 1 is positioned so that said gateway 13 is radially aligned with said pins 11 and 12.

Thus, each gateway 13 of the plurality of gateways transmits current between the two pins 11 and 12 of a pair of pins 10 when the movable piece 1 is positioned so that said gateway 13 is radially aligned with said pair of pins 10.

The gateways 13 of the plurality of gateways are spaced apart from each other on the movable piece 1. The spacing between each of the gateways 13 is constant and does not change during the motion of the movable piece 1.

They are positioned on the movable piece 1 so that, for each position occupied by the movable piece 1, the electrical contact is only established between the pins 11 and 12 of the pairs of pins 10 associated with the RFID tags 4 forming a single combination of RFID tags for said position occupied by the movable piece 1.

In other words, at each position of the movable piece 1, a single combination of at least one RFID tag of the plurality of tags 4 is defined. This combination of tags corresponds to the tags 4 intended to be activated, that is to receive the electric current from the antenna 3 when the antenna 3 receives a request to query from the RFID reader L that the movable piece 1 occupies a given position.

Thus, the gateways 13 are spaced apart and positioned on the movable piece 1 so that for each position of the movable piece 1, only the pairs of pins 10 associated with the RFID tags forming the single combination for said possible position are radially aligned with a gateway 13.

Thus, in the illustrated example, the plurality of gateways 13 comprises a first gateway 13a, a second gateway 13b and a third gateway 13c spaced apart by an axial distance at least equal to an axial dimension of the ends of the pins 11 and 12 to be in contact with the gateways 13. The gateways 13a, 13b and 13c are translationally integral with the movable piece 1 along the movement path.

The first gateway 13a and the third gateway 13c axially extend over a distance substantially equal to the axial dimension of the ends of the pins 11 and 12 to be in contact with the gateways 13, whereas the second gateway 13b, which is axially positioned between the first gateway 13a and the third gateway 13c axially extends over a distance substantially comprised between two and two and a half times the axial dimension of the ends of the pins 11 and 12 to be in contact with the gateways 13. The second gateway 13b therefore axially extends over a distance substantially comprised between two and two and a half times the axial dimension of the first and third gateways 13a and 13c.

Thus, when the movable piece 1 occupies the first extreme position illustrated in FIG. 3, no gateway 13 is radially aligned with the first pair of pins 10a so that no electrical connection is established between the RFID tag 4a and the antenna 3. On the contrary, the gateways 13b and 13c are aligned with the pairs of pins 10b and 10c respectively, so that an electrical connection is established between the antenna 3 and the RFID tags 4b and 4c. In this way, if the antenna 3 receives a request to query from the RFID reader while the movable piece 1 occupies this first position, only the RFID tags 4b and 4c are activated and capable of formulating a response and transmitting it to the antenna 3 for emission to the RFID reader L.

The single combination of RFID tags for the first extreme position therefore comprises the RFID tags 4b and 4c.

Similarly, when the movable piece 1 occupies the intermediate position illustrated in FIG. 4, no gateway 13 is axially aligned with the first pair of pins 10a and the third pair of pins 10c, so that no electrical connection is established between the RFID tags 4a, 4c and the antenna 3. On the contrary, only the gateway 13b is radially aligned with the pair of pins 10b, so that an electrical connection is established between the antenna 3 and the RFID tag 4b. In this way, if the antenna 3 receives a request to query from the RFID reader L while the movable piece 1 occupies this intermediate position, only the RFID tag 4b is activated and is capable of formulating a response and transmitting it to the antenna 3 for emission to the RFID reader L.

The single combination of RFID tags for the intermediate position therefore only includes the RFID tag 4b.

Finally, when the movable piece 1 occupies the second extreme position illustrated in FIG. 5, no gateway 13 is axially aligned with the third pair of pins 10c so that no electrical connection is established between the RFID tag 4c and the antenna 3. On the contrary, the gateways 13a and 13b are aligned with the pairs of pins 10a and 10b respectively, so that an electrical connection is established between the antenna 3 and the RFID tags 4a and 4b. In this way, if the antenna 3 receives a request to query from the RFID reader L while the movable piece 1 occupies this second extreme position, only the RFID tags 4a and 4b are activated and are capable of formulating a response and transmitting it to the antenna 3 for emission to the RFID reader L.

The single combination of RFID tags for the second extreme position therefore comprises the RFID tags 4a and 4b.

The mechanical contact switch 5 is thus configured to establish an electrical connection between the antenna 3 and a single combination of at least one RFID tag of the plurality of RFID tags 4 for each position of the movable piece 1.

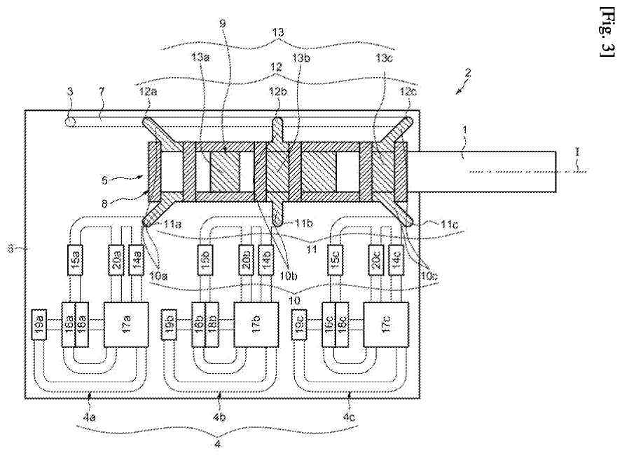

FIG. 2 illustrates the RFID tag 4a. The RFID tags 4 of the plurality of RFID tags are identical, so that the following description of the first tag 4a also applies to the tags 4b and 4c and to all of the tags 4 of the plurality of RFID tags.

The RFID tag 4a is a conventional passive RFID tag, that is, without an onboard battery and powered only by an electromagnetic wave emitted by the remote RFID reader L and sensed by the antenna 3.

The RFID tag 4a comprises a demodulator 14a, a converter 15a, a voltage regulator 16a, a calculator 17a, a reset system 18a for resetting the calculator 17a, an internal clock 19a, and a reverse modulator 20a.

The demodulator 14a and the converter 15a are each directly connected to the first pin 11a of the pair of pins 10a associated with the RFID tag 4a so that the antenna 3 delivers the electrical signal resulting from the electromagnetic wave as an input of the demodulator 14a and the converter 15a when a gateway 13 is aligned with said pair of pins 10a and a request to query is sensed by the antenna 3.

The converter 15a ensures the conversion of the electrical signal received by the antenna 3 into a direct current. The converter 15a delivers the direct current converted as an output to the voltage regulator 16a, on the one hand, and to the reset system 18a, on the other hand.

Thus, the voltage regulator 16a is directly connected to the output of the converter 15a so that the converter 15a delivers an electric current to the voltage regulator 16a.

The voltage regulator 16a is connected as an output to the internal clock 19a on the one hand and to the calculator 17a on the other hand.

The voltage regulator 16a therefore receives as an input the electric current generated by the converter 15a and is capable of delivering as an output a direct voltage adapted for powering the calculator 17a and for powering the internal clock 19a.

The reset system 18a for resetting the calculator is also directly connected to the output of the converter 15a so that the converter 15a delivers an electric current generated as an input of the reset system 18a. The reset system 18a is furthermore directly connected as an output to the calculator 17a.

The reset system 18a consists of a known system of the PoR type, abbreviation for “Power-on Reset”, able to initialise or reset the calculator 17a when an electric current is applied to the system 18a.

The reset system 18a therefore receives as an input the electric current generated by the converter 15a and resets the calculator 17a.

The demodulator 14a is connected as an input to the first branch 11a of the pair of pins 10a associated with the RFID tag 4a so that the demodulator 14a is capable of receiving the signal received by the antenna 3 when a gateway 13 is aligned with said pair of pins 10a. The demodulator 14a is connected as an output to the calculator 17a.

The demodulator 14a ensures the demodulation of the electrical signal received by the antenna 3 and provides the signal demodulated as an input of the calculator 17a. In other words, the demodulator 14a continuously converts, demodulates the signal received by the antenna 3 and sends it to the calculator 17a. The electrical signal delivered by the antenna 3 to the demodulator 14a is thus a signal modulated.

The internal clock 19a is directly connected to the calculator 17a and is configured to send time information to the calculator 17a in order to allow synchronisation of the tasks performed by the calculator 17a.

The calculator 17a is an integrated circuit capable of processing the demodulated request to query transmitted by the demodulator 14a, that is, verifying that the request to query is correct, formulating a response to the request to query, and transmitting the response to the reverse modulator 20a.

The calculator 17a is thus directly connected to the reverse modulator 20a.

The reverse modulator 20a is a component known from the passive RFID tags intended to modulate the response formulated by the calculator 17a using the wave sensed from the RFID reader and received by the antenna 3.

The reverse modulator 20a is thus directly connected to the first pin 11a of the pair 10a associated with the RFID tag 4a, so as to be capable of transmitting the electrical signals directly to the antenna 3 when a gateway 13 is radially aligned with the pins 11a and 12a of the pair 10a.

The reverse modulator 20a provides the antenna 3 with the response modulated as an output through the pair of pins 10a and a gateway 13 radially aligned with the pair of pins 10a. The antenna 3 is capable of emitting an electromagnetic wave and transmitting the response modulated to the RFID reader L.

The RFID tags 4 of the plurality of RFID tags are identical in design, so that the foregoing description also applies to the tags 4b and 4c and to all of the tags 4 of the plurality of RFID tags.

Thus, the RFID tag 4b also comprises a demodulator 14b, a converter 15b, a voltage regulator 16b, a calculator 17b, a reset system 18b for resetting the calculator 17b, an internal clock 19b and a reverse modulator 20b. The RFID tag 4b operates identically to the RFID tag 4a previously described.

Similarly, the RFID tag 4c also comprises a demodulator 14c, a converter 15c, a voltage regulator 16c, a calculator 17c, a reset system 18c for resetting the calculator 17c, an internal clock 19c, and a reverse modulator 20c. The RFID tag 4c operates identically to the RFID tag 4a previously described.

Nonetheless, each of the RFID tags 4 has a single identifier so that it can be targeted by a request sent by the RFID reader L. Alternatively, the RFID tags 4 could each be of a different design.

The detection device 2 ensures detection of the position occupied by the movable piece 1 moving between the first extreme position and the second extreme position, and at least one intermediate position.

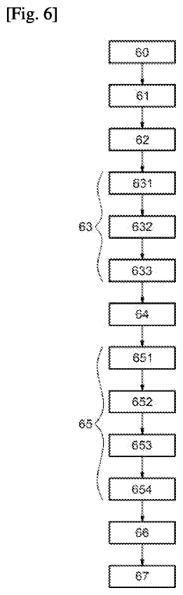

FIG. 6 illustrates the steps of such a method for detecting the position of a movable piece 1 between a first extreme position, a second extreme position and at least one intermediate position. The following description of the method illustrates this method by an example in which the movable piece 1 occupies the first extreme position, corresponding to FIG. 3.

During a first step 60, the remote radio-frequency identification reader L emits a request to query the position occupied by the movable piece 1 intended for one of the tags of the plurality of tags, in particular here for example for the tag 4a.

During a second step 61, the antenna 3 receives as an input an electromagnetic wave emitted by the RFID reader L, the electromagnetic wave received corresponding to the request to query of the RFID tag 4a emitted by the remote RFID reader L in step 60.

During a next step 62, the RFID tags 4 forming the single combination of RFID tags for the position occupied by the movable piece 1 are sequentially queried, one after the other.

During step 62, the signal received by the antenna 3 is transmitted on the track 7, and therefore propagates to the second pins 12a, 12b and 12c of the pairs of pins 10.

The signal received is then transmitted only to the first pins 11 of the pairs 10 with which a gateway 13 is aligned and establishes an electrical contact.

In the example described, the movable piece 1 occupies the first position illustrated in FIG. 3. When the movable piece 1 occupies this first extreme position, no gateway 13 is radially aligned with the first pair of pins 10a so that no electrical connection is established between the RFID tag 4a and the antenna 3. On the contrary, the gateways 13b and 13c are aligned with the pairs of pins 10b and 10c respectively, so that an electrical connection is established between the antenna 3 and the RFID tags 4b and 4c.

Thus, the signal received by the antenna 3 and transmitted to the second pins 12a, 12b and 12c is therefore transmitted by the gateways 13b and 13c to the first pins 13b and 13c of the pairs of pins 10b and 10c, whereas the gateway 13a does not establish electrical contact between the pins 11a and 12a. The second pins that have received the signal then transmit this signal to the RFID tags to which they are connected, which are thus activated.

Thus, in this example, only the tags 4b and 4c are activated. In other words, only the tags 4b and 4c receive the electrical signal received by the antenna 3 for powering thereof.

During a subsequent phase 63 of the method, the request to query is processed by each RFID tag activated. More specifically, each of the RFID tags activated in step 62 individually carries out the phase 63. Thus, in the example illustrated in FIG. 3, the phase 63 is implemented by the RFID tags 4b and 4c.

This phase 63 comprises a first step 631 in which the request to query is demodulated by the demodulator of each RFID tag activated.

The request to query demodulated is then transmitted to the calculator of the RFID tags activated (step 632), which verifies the validity of the request to query (step 633). More specifically, the step 633 of verifying the validity of the request to query consists in the calculator of each RFID tag activated verifying that the request is indeed intended for the tag to which said calculator belongs, and verifying that the request is correct. If these two conditions are met, the request to query is validated by said calculator, otherwise it is not validated.

In the example illustrated in FIG. 3, the tags activated are the tags 4b and 4c, and the request to query emitted is first the request intended for the tag 4a. Thus, the request is demodulated by the demodulators 14b and 14c of the tags 4b and 4c activated, then transmitted respectively by these demodulators to the calculators 17b and 17c of the active tags 4b and 4c, which then verify the validity of this request.

Since the request received at this stage is the request intended for the tag 4a, none of the calculators 17b and 17c validate the request to query received.

During the next step 64, according to the result of the phase 63 for processing the request, the calculator of each RFID tag activated formulates a response to the request to query emitted by the remote RFID reader L. The response formulated comprises for example a simple confirmation that the RFID tag is activated. More specifically, this step 64 of formulating a response is performed only if the request to query has been validated during the processing phase 63, and more particularly during the verification sub-phase 633.

If, on the contrary, the request to query is not validated by the calculator of the tag activated during step 633, then no response is formulated, and the method goes directly to a step 66 described below.

In the example illustrated in FIG. 3, the calculators 17b and 17c thus do not formulate any response since the request to query has not been validated.

In the case where the step 64 of formulating a response has been performed, this response formulated is sent by the antenna 3 to the remote radio-frequency identification reader L (step 65). More specifically, this step 65 comprises a first sub-step 651 of transmitting the response formulated by the calculator to the reverse modulator of the same tag. In a second sub-step 652, the reverse modulator modulates the response formulated, then transmits this response modulated to the antenna 3 through the connection pins and gateways previously described (sub-step 653). In a sub-step 654, the antenna 3 sends this response modulated to the remote radio-frequency identification reader L which receives it (sub-step 654).

In a subsequent step 66, all of the previous steps 60 to 65 are repeated for each of the remaining tags of the plurality of tags, so that these steps 60 to 65 are carried out once for each of the tags of the plurality of tags.

More specifically, this step 66 is implemented once a response to the previous request to query has been received by the remote RFID reader L, that is, once step 654 is completed. In the case where the request to query has not been validated by the calculators of the tags activated in step 63, that is, in the case where no response has been received by the RFID reader L and therefore steps 64 and 65 have not been performed, step 66 is implemented upon expiry of a predetermined maximum response time.

In the example described in FIG. 3, the request to query has not been validated by any of the calculators 17b and 17c of the tags 4b and 4c activated. No response is therefore formulated, transmitted or received by the RFID reader L. At the end of the maximum response time elapsed since the sending of the request to query intended for the tag 4a by the RFID reader L, this RFID reader L emits a request to query intended for the tag 4b in a first repetition of step 60.

This request intended for the tag 4b, like the previous request intended for the tag 4a, is sensed by the antenna 3, transmitted on the track 7 then received by the tags 4b and 4c which are activated by reception thereof. The request to query is then individually processed by each of the RFID tags activated, that is, here by the tags 4b and 4c.

During this processing step 63 carried out by each of the tags 4b and 4c activated, the request to query intended for the tag 4b is thus demodulated by the demodulators 14b and 14c of these tags, then transmitted to the calculators 17b and 17c of these tags which perform the verification thereof.

The calculator 17c, as previously, does not validate the request as this request is intended for the tag 4b. The calculator 17c therefore does not formulate any response to this request.

On the contrary, the calculator 17b validates the request during the processing step 63, and therefore formulates a response to this request during the step 64.

The next step 65 consists in transmitting, by the calculator 17b, the response formulated to the reverse modulator 20b, then modulating this response formulated by said reverse modulator 20b, transmitting this response modulated to the antenna 3 through the pair of pins 10b and the gateway 13b, then finally transmitting, by the antenna 3, the response modulated to the RFID reader L.

The RFID reader L then receives the response modulated formulated by the calculator 17b of the tag 4b, and can therefore emit a request to query intended for the last of the remaining tags of the plurality of tags, namely the tag 4c, during a last repetition 66 of the steps 60 to 65.

Like the phase concerning the request intended for the tag 4b, this request intended for the tag 4c is transmitted to the tags 4b and 4c which are therefore activated, and only the tag 4c formulates and transmits a response to the RFID reader L for this request, the tag 4b not having validated the request during the processing step. The RFID reader L therefore receives a response from the tag 4b to its request to query intended for the tag 4b.

A request intended for each of the tags 4a, 4b, and 4c has therefore been emitted by the RFID reader L, which concludes the repetition step 66.

Finally, in a subsequent final step 67 of the method, the position occupied by the movable piece 1 is determined. This step 67 is implemented when the RFID reader L has performed step 60 for each of the tags of the plurality of tags, and it receives a response to the last request it has sent or the maximum response time since sending this last request has elapsed. In other words, step 67 is implemented at the end of the final repetition 66 of steps 60 to 65.

More specifically, this step 67 is performed by the RFID reader L. Depending on the responses received or not emanating from the RFID tags by the RFID reader L following the emissions of a request to query intended for each of the tags of the plurality of tags, the RFID reader L can determine which tags are activated, and thus reconstitute the single combination of activated RFID tags associated with the position occupied by the movable piece 1. Indeed, a lack of response by an RFID tag to a request to query intended for this RFID tag means that the movable piece 1 does not occupy a position in which a gateway 13 is radially aligned with the pair of pins 10 associated with this RFID tag. The RFID reader can then determine by correspondence the position occupied by the movable piece 1.

In the case of the example illustrated in FIG. 3, following the repetitions of steps 60 to 65 for each of the tags 4a, 4b and 4c of the plurality of tags, the RFID reader L has received, as described above, a response only from the tags 4b and 4c. The position occupied by the movable piece 1 is therefore the position corresponding to the single combination of the tags 4b and 4c, which is as previously described the first extreme position.

The detection device 2 therefore uses radio-frequency identification technology to provide a reliable and constantly consultable position sensor of the movable piece 1, the sensor requiring neither an onboard battery nor a wired connection for data portability or for powering the sensor.

1. A device for detecting the position of a movable piece between a first extreme position, a second extreme position and at least one intermediate position, the detection device comprising a fixed antenna and a plurality of radio-frequency identification tags disposed along the path of the movable piece between said extreme and intermediate positions, the device comprising a mechanical contact switch configured to establish an electrical connection between the antenna and a single combination of at least one radio-frequency identification tag for each position of the movable piece.

2. The detection device according to claim 1, wherein the mechanical contact switch is disposed around the movable piece and comprises a fixed armature and a movable portion integral with the movable piece.

3. The detection device according to claim 2, wherein the fixed armature comprises a plurality of pairs of connection pins, each radio-frequency identification tag being associated with a single pair of pins comprising a first pin in contact with the radio-frequency identification tag to which said pair of pins is associated and a second pin in contact with the antenna.

4. The detection device according to claim 3, wherein the movable portion is secured to the movable piece and comprises a plurality of gateways capable of transmitting current between the two pins of a pair of connection pins.

5. The detection device according to claim 4, wherein the plurality of gateways are positioned on the movable piece so that, for each position occupied by the movable piece, current is transmitted only between the pins of the pairs associated with the radio-frequency identification tags forming the single combination of radio-frequency identification tag for said position occupied by the movable piece.

6. A method for detecting the position of a movable piece between a first extreme position, a second extreme position and at least one intermediate position, for implementing a detection device according to claim 1, comprising the following steps of:
Emitting, by a remote radio-frequency identification reader, a request to query the position occupied by the movable piece intended for one of the tags of the plurality of tags;
Receiving, by the antenna, the request to query emitted by the radio-frequency identification reader;
Activating the radio-frequency identification tags of the single combination of tags for said position occupied by the movable piece;
Individually processing, by each tag activated, the request to query;
According to the result of the processing, formulating, by the radio-frequency identification tag for which the request to query is intended, an individual response to the request to query, if this tag is activated;
Emitting, by the antenna, the individual response formulated of the tag to the radio-frequency identification reader;
Repeating the previous steps for each of the other tags of the plurality of tags, so that a request to query is emitted by the radio-frequency identification reader for each of the tags of the plurality of tags; and
Determining the position occupied by the movable piece.

7. The method according to claim 6, wherein the radio-frequency identification tags of the plurality of tags each comprise a calculator, the step of individually processing, by each tag activated, the request to query comprising the following steps of, for each tag activated:
Demodulating the request to query;
Transmitting the request demodulated to the calculator; and
Verifying the validity of the request to query.

8. The method according to claim wherein the repetition of the emission step is carried out after receiving a response to the previous request to query by the remote radio-frequency identification reader, or after a predetermined time during which no response has been received by the remote radio-frequency identification reader following the emission.

9. An aircraft comprising a detection device according to claim 1.

10. An aircraft comprising a detection device according to claim 1, wherein the detection device is capable of implementing a method for detecting the position of a movable piece between a first extreme position, a second extreme position and at least one intermediate position, for implementing the detection device and comprising the following steps of:
Emitting, by a remote radio-frequency identification reader, a request to query the position occupied by the movable piece intended for one of the tags of the plurality of tags;
Receiving, by the antenna, the request to query emitted by the radio-frequency identification reader;
Activating the radio-frequency identification tags of the single combination of tags for said position occupied by the movable piece;
Individually processing, by each tag activated, the request to query;
According to the result of the processing, formulating, by the radio-frequency identification tag for which the request to query is intended, an individual response to the request to query, if this tag is activated;
Emitting, by the antenna, the individual response formulated of the tag to the radio-frequency identification reader;
Repeating the previous steps for each of the other tags of the plurality of tags, so that a request to query is emitted by the radio-frequency identification reader for each of the tags of the plurality of tags; and
Determining the position occupied by the movable piece.
